(19) United States
(12) Patent Application Publication
(10) Pub. No.: US 2016/0141967 A1
(43) Pub. Date: May 19, 2016

(54) DC POWER SUPPLY SYSTEM

(71) Applicant: DELTA ELECTRONICS, INC., Taoyuan Hsien (CN)

(72) Inventors: Chao YAN, Taoyuan Hsien (CN); Liping SUN, Taoyuan Hsien (CN); Lihao YAN, Taoyuan Hsien (CN)

(21) Appl. No.: 14/879,249

(22) Filed: Oct. 9, 2015

(30) Foreign Application Priority Data
Nov. 18, 2014 (CN) 201410663336.6

(51) Int. Cl. H02M 3/335

(52) U.S. Cl. CPC H02M 3/33546

(57) ABSTRACT

Embodiments of the present disclosure provide a direct current (DC) power supply system, comprising: a medium voltage AC switchgear, configured to distribute a medium voltage three-phase AC received from an external supply for a next stage; a phase-shift transformer serving as the next stage, coupled to the medium voltage AC switchgear, and configured to lower the medium voltage three-phase received and output four or more groups of low voltage three-phase AC; and an uncontrolled rectifying circuitry, comprising a plurality of uncontrolled rectifiers configured to receive the four or more groups of low voltage three-phase AC respectively and output a low voltage DC; wherein the four or more groups of low voltage three-phase AC have a predetermined phase difference between each other.

### CROSS REFERENCE TO RELATED APPLICATION

This application is based on and claims priority to Chinese Patent Application No. 201410663336.6, filed on Nov. 18, 2014, the entire contents of which are incorporated herein by reference.

### TECHNICAL FIELD

The present disclosure relates generally to the field of DC power supply technology, and more particularly, to a high-efficiency DC power supply system.

### BACKGROUND

Since entering the information era, industrial equipment (e.g., telecom centers and data centers, etc.) has been increased phenomenally. Thus, more electric power is required for DC systems supplying power for industrial equipment. DC (Direct Current) is converted from AC (Alternating current), and it is an important link to convert medium voltage AC to low voltage DC. Therefore, the high-efficiency DC power supply system is a development trend of the power supply system for industrial equipment.

A majority of conventional DC power supply systems for telecom centers or data centers is implemented in such a way that medium voltage AC supplied by power grids is converted by industrial frequency transformers into low voltage AC, and the low voltage AC outputted is converted into low voltage DC by a UPS (Uninterrupted Power Supply) and an AC/DC converter, or low voltage DC is outputted by means of a three-phase active front end (AFE), a DC/DC converter together with a backup battery and another DC/DC converter. Low voltage DC obtained from either mode may be configured to supply power for multiple loads in a central apparatus room.

### SUMMARY

Embodiments of the disclosure are intended to provide a DC power supply system so as to achieve miniaturization and simplification of the DC power supply systems, and at the same time, guarantee conversion efficiency and reliability of the systems.

In order to realize the foregoing objective, embodiments of the present disclosure provide a DC power supply system, comprising: a medium voltage AC switchgear, configured to distribute a medium voltage three-phase AC received from an external supply for a next stage; a phase-shift transformer serving as the next stage, coupled to the medium voltage AC switchgear, and configured to lower the medium voltage three-phase received and output four or more groups of low voltage three-phase AC; and an uncontrolled rectifying circuitry, comprising a plurality of uncontrolled rectifiers configured to receive the four or more groups of low voltage three-phase AC respectively and output a low voltage DC; wherein the four or more groups of low voltage three-phase AC have a predetermined phase difference between each other.

It can be known from the foregoing technical solution that, in the DC power supply system according to embodiments of the present disclosure, the phase-shifting transformer may realize a conversion from medium voltage AC to low voltage AC, the uncontrolled rectifying circuitry may convert AC into DC, thus meeting requirements for the conversion from medium voltage AC to low voltage DC.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 shows a circuit block diagram illustrating an implementation model of a typical DC power supply system.

FIG. 2 shows a circuit block diagram illustrating another implementation model of a typical DC power supply system.

FIGS. 3-5 respectively show circuit block diagrams of DC power supply system according to embodiments of the disclosure.

FIG. 6 shows a schematic diagram of a phase-shifting transformer according to an embodiment.

FIG. 7 shows a schematic diagram of an uncontrolled rectifier according to an embodiment.

FIGS. 8-10 respectively show schematic diagrams of an uncontrolled rectifying circuitry according to embodiments.

FIG. 11 and FIG. 12 respectively show schematic diagrams of a first-order DC-DC converter and a second-order DC-DC converter according to embodiments.

FIG. 13 and FIG. 14 respectively show schematic diagrams of a DC/DC converter according to embodiments.

### DETAILED DESCRIPTION

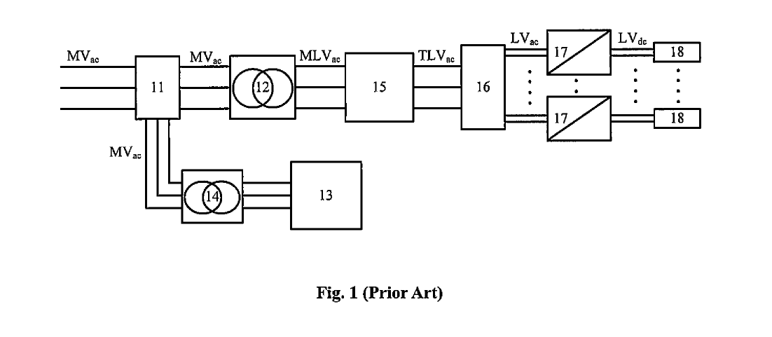

FIG. 1 is an electrical block diagram illustrating an implementation model of the DC power supply system, which shows a typical medium voltage AC-low voltage DC conversion system. In FIG. 1, MV_{ac} indicates medium voltage AC, with a typical voltage range of 1 kV AC-50 kV AC (both 1 kV AC and 50 kV AC are effective values; unless otherwise specified, following AC voltage values are also effective values); MLV_{ac} and TLV_{ac} indicate low voltage three-phase AC, with a typical voltage of 380V AC; LV_{ac} indicates single-phase low voltage AC, with a typical voltage of 220V AC; LV_{dc} indicates low voltage DC, with a typical voltage of 12V DC.

The operating condition of the DC power supply system as shown in FIG. 1 is described as below. Under nominal operating condition, a standby generator 13 doesn't work, and medium voltage AC MV_{ac} is distributed by means of a medium voltage AC switchgear 11. The medium voltage AC switchgear 11 substantially includes an circuit interrupter, a disconnecting switch, an actuating mechanism and other parts (not shown in the drawing), has functions of on-off; control and protection, etc., and is available for taking medium voltage AC MV_{ac} as input of an industrial frequency transformer 12, or taking medium voltage AC MV_{ac} outputted by a boosting transformer 14 as input of the industrial frequency transformer 12, and additionally switching off input of the industrial frequency transformer 12. Then, medium voltage AC MV_{ac} is converted by the industrial frequency transformer 12 into low voltage three-phase AC MLV_{ac}, wherein the industrial frequency transformer 12 is applicable to AC with a frequency of 40 Hz-70 Hz, and is capable of changing the voltage amplitude of AC. Low voltage three-phase AC MLV_{ac} can be converted by a UPS (Uninterrupted Power Supply) 15 into another low voltage three-phase AC TLV_{ac}. The UPS 15 substantially includes a main circuit, a bypass circuit, a battery, an inverter circuit and the like, and is available for controlling outputting of the low voltage three-phase AC TLV_{ac}. When input of the low voltage three-phase AC MLV_{ac} is good, the UPS 15 stabilizes voltage of the low voltage three-phase AC MLV_{ac} and then outputs another low voltage three-phase AC TLV_{ac}; when input of the low voltage three-phase AC MLV_{ac} is interrupted, the UPS 15 inverts DC of the battery into another low voltage three-phase AC TLV_{ac} required for AC output; the UPS 15 may also select to switch off outputting of the low voltage three-phase AC TLV_{ac}. The low voltage three-phase AC TLV_{ac} is distributed by a low voltage three-phase AC switchgear 16 to single-phase low voltage AC LV_{ac}, where the low voltage three-phase AC switchgear 16 substantially includes a circuit interrupter, a disconnecting switch, an actuating mechanism and other parts, and has functions of on-off, control and protection, etc. Subsequently, the single-phase low voltage AC LV_{ac} is converted by an AC-DC converter 17 into low voltage DC LV_{dc}, which is finally used for supplying various loads 18 with power. Under abnormal operating condition, if the medium voltage AC MV_{ac} is too low (e.g., lower than 90% of typical voltage), the standby generator 13 is started, and medium voltage AC MV_{ac} is outputted by the boosting transformer 14, and then the medium voltage AC MV_{ac} is supplied to a system via the medium voltage AC switchgear 11. In the system as shown in FIG. 1, a mode may be adopted in which there are multiple outputs of the AC-DC converter 17.

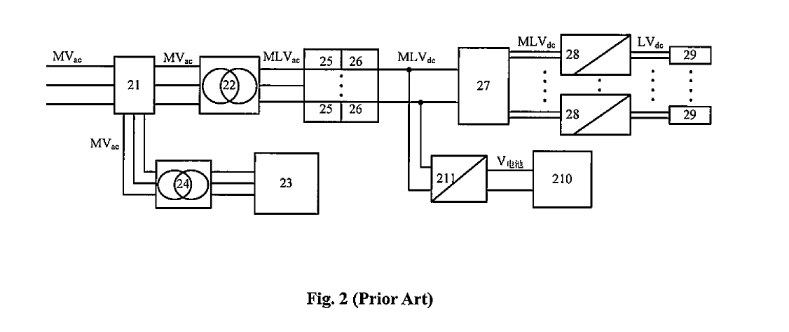

FIG. 2 is an electrical block diagram illustrating another implementation model of the DC power supply system, which shows another typical medium voltage AC-low voltage DC conversion system. Similar to FIG. 1, in FIG. 2, MV_{ac} indicates medium voltage AC, with a typical voltage range of 1 kV AC-50 kV AC; MLV_{ac} indicates low voltage three-phase AC, with a typical voltage of 380V AC; MLV_{dc} indicates low voltage DC, with a typical voltage of 380V DC; and LV_{dc} indicates another low voltage DC, with a typical voltage of 12V DC.

The operating condition of the DC power supply system as shown in FIG. 2 is described as below. Under normal operating condition, neither a standby generator 23 nor a backup battery 210 works. Medium voltage AC MV_{ac} is distributed by means of a medium voltage AC switchgear 21, and is converted by an industrial frequency transformer 22 into low voltage three-phase AC MLV_{ac}. The low voltage three-phase AC MLV_{ac} is converted into low voltage DC MLV_{dc} by a three-phase active front end (AFE) 25 and a DC-DC converter D2D 26, wherein the three-phase active front end (AFE) 25 can convert AC by rectification into DC, and simultaneously eliminate higher harmonic by means of active control, thus improving power factor and other functions. Low voltage DC MLV_{dc} is distributed by a low voltage DC switchgear 27, wherein the low voltage DC switchgear 27 substantially includes a circuit interrupter, a disconnecting switch, an actuating mechanism and other parts, and has functions of on-off, control and protection, etc. Then, low voltage DC MLV_{dc} is converted by a DC-DC converter 28 into another low voltage DC LV_{dc}, which is finally used for supplying various loads 29 with power. Under abnormal operating condition, if the medium voltage AC MV_{ac} is too low (e.g., lower than 90% of typical voltage), the standby generator 23 is started, and medium voltage AC MV_{ac} is outputted by the boosting transformer 24, and then the medium voltage AC MV_{ac} is supplied to a system via the medium voltage AC switchgear 21. If the low voltage DC MLV_{dc} is too low (e.g., lower than 90% of typical voltage), a backup battery 210 is started, and battery voltage V_{battery} is converted by a DC-DC converter 211 into required low voltage DC MLV_{dc}, which is then used for maintaining power supply of the DC power supply system via the low voltage DC switchgear 27. In the system as shown in FIG. 2, a mode may be adopted in which there are multiple parallel channels of the AFE 25 and the D2D 26, and also there may be multiple outputs of the DC-DC converter 28.

Embodiments of the disclosure are described in detail as below. It is to be noticed that the embodiments described herein are only for illustration, and not restrictive of the present disclosure.

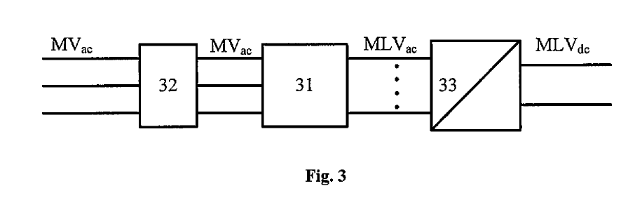

An embodiment of the DC power supply system according to the present disclosure is as shown in FIG. 3, including: a phase-shifting transformer 31, a medium voltage AC switchgear 32 and an uncontrolled rectifying circuitry 33. Wherein, the medium voltage AC switchgear 32 is configured to distribute a medium voltage three-phase AC MV_{ac} received from an external supply for a next stage; the phase-shifting transformer 31 serves as the next stage, and is coupled to the medium voltage AC switchgear to lower the medium voltage three-phase AC received and output four or more groups of low voltage three-phase AC MLV_{ac}; and the uncontrolled rectifying circuitry 33 is configured to receive the low voltage three-phase AC MLV_{ac} outputted by the phase-shifting transformer 31 and output low voltage DC MLV_{ac}. In an embodiment, the foregoing medium voltage three-phase AC MV_{ac} has a voltage range of 1 kV-50 kV and a frequency less than 100 Hz; the foregoing low voltage three-phase AC MLV_{ac} has a voltage range of 100V-700V (e.g., 380V typically) and a frequency less than 100 Hz; and the foregoing low voltage DC MLV_{dc} has a voltage range of 100V-800V (e.g., 380V or 270V typically).

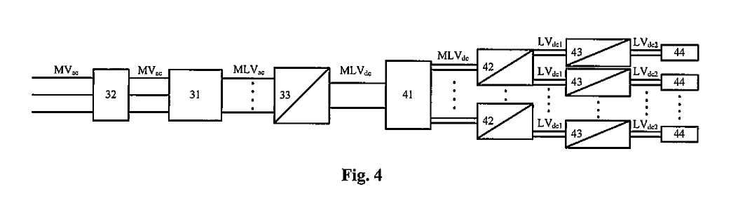

Another embodiment of the DC power supply system according to the present disclosure is as shown in FIG. 4. Based on the embodiment as shown in FIG. 3, the DC power supply system in the embodiment also includes a low voltage DC switchgear 41, a first-order DC-DC converter 42 and a second-order DC-DC converter 43. Wherein, the low voltage DC switchgear 41 is configured to receive the low voltage DC MLV_{dc} outputted by the uncontrolled rectifying circuitry 33 and output a supply low voltage DC MLV_{dc} after distribution; the first-order DC-DC converter 42 is configured to receive the supply low voltage DC MLV_{dc} and output first low voltage DC LV_{dc1}; the second-order DC-DC converter 43 is configured to receive the first low voltage DC LV_{dc1} and output second low voltage DC LV_{dc2} to a load 44. In an embodiment, the first low voltage DC LV_{dc1} has a voltage range of 0V-100V; and the second low voltage DC LV_{dc2} has a voltage range of 0V-5V. As shown in FIG. 3, in the embodiment, the first-order DC-DC converter 42 may output multiple channels of low voltage DC LV_{dc1}, thus reducing the size of the system and improving the efficiency of the system.

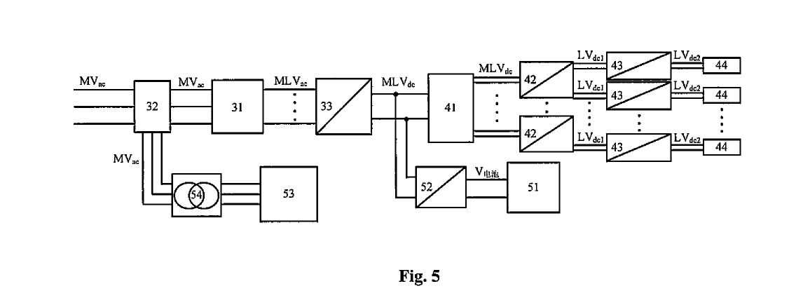

A further embodiment of the DC power supply system according to the present disclosure is as shown in FIG. 5. Based on the embodiment as shown in FIG. 4, the DC power supply system in the embodiment further includes a backup battery 51, a DC-DC converter 52, a standby generator 53 and a boosting transformer 54. Wherein, the backup battery 51 is configured to provide a backup DC V_{battery}; the DC/DC converter 52 is connected with the backup battery 51, and configured to convert the DC V_{battery} outputted by the backup battery 51 into another low voltage DC MLV_{dc} and transmit the MLV_{dc} to the low voltage DC switchgear 41. The standby generator 53 is configured to provide a standby medium voltage three-phase AC from external supply; and the boosting transformer 54 is connected with the standby generator 53, and configured to transmit the standby medium voltage three-phase AC from external supply provided by the standby generator 53 to the medium voltage AC switchgear 32. In an embodiment, the backup battery 51 may be started to provide the backup DC when the low voltage DC voltage MLV_{dc} outputted by the uncontrolled rectifying circuitry 33 is below a setting range. Similarly, in another embodiment, the standby generator 53 may be started to provide the backup medium voltage three-phase AC from external supply when the medium voltage three-phase AC voltage MV_{ac} from external supply inputted into the medium voltage AC switchgear 32 is below another setting range.

The DC power supply system in the foregoing embodiment uses a phase-shifting transformer and an uncontrolled rectifying circuitry to achieve a conversion from medium voltage AC to low voltage DC. When compared with the typical system including an industrial frequency transformer and a UPS in FIG. 1, both energy consumption and size of the whole system may be reduced. In addition, when compared with the typical system including an AFE and a DC-DC converter in FIG. 2, simplification of the whole system may be realized. Therefore, the DC power supply system in the foregoing embodiment may have smaller size, and may be available for realizing higher power density and conversion efficiency, to which an elaboration will be made in detail in the following embodiments.

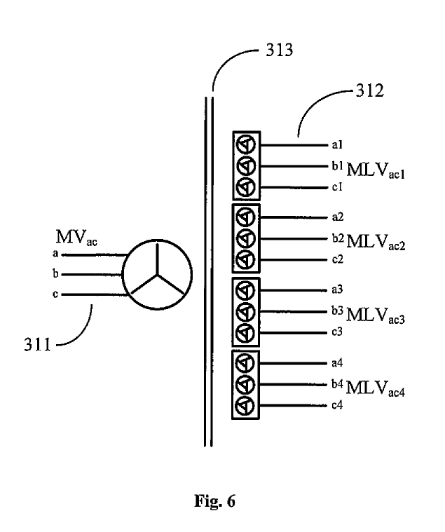

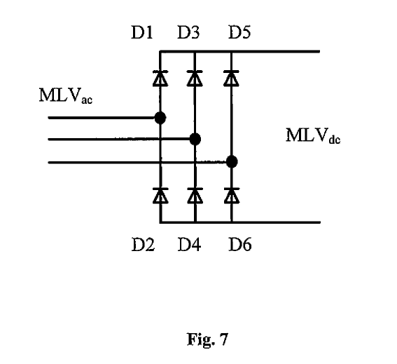

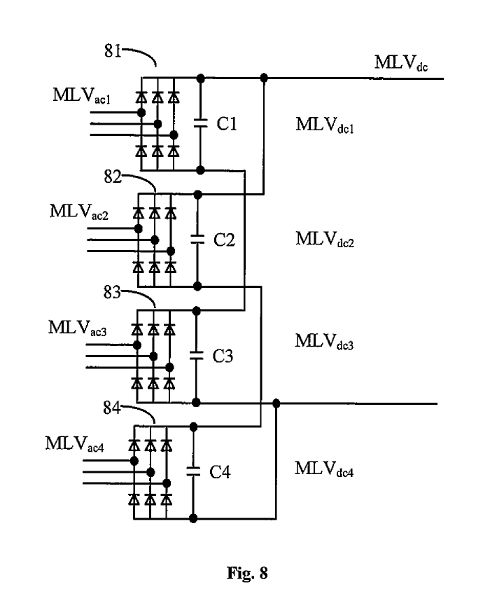

In an embodiment, the phase-shifting transformer 31 may output the low voltage three-phase AC of an even number (greater than or equal to four) of groups. Correspondingly, in an embodiment, the uncontrolled rectifying circuitry 33 includes an even number of (greater than or equal to four) uncontrolled rectifiers, and each of the uncontrolled rectifiers may receive one group of the low voltage three-phase AC MLV_{ac}. Wherein, every two uncontrolled rectifiers are connected in series with each other and then connected in parallel with output of other uncontrolled rectifiers connected in series. Referring to FIGS. 6-10, FIG. 6 shows a schematic diagram of the foregoing phase-shifting transformer according to an embodiment, FIG. 7 shows a schematic diagram of the foregoing uncontrolled rectifiers according to an embodiment, and FIGS. 8-10 show schematic diagrams of the uncontrolled rectifying circuitry according to embodiments.

First of all, as shown in FIG. 6, the phase-shifting transformer 31 in the embodiment includes a primary side winding 311 configured to receive the medium voltage three-phase AC, a secondary side winding 312 configured to output low voltage three-phase AC, and an iron core 313. Four secondary side windings 312 are shown in the embodiment of FIG. 6, corresponding to four groups of low voltage three-phase AC MLV_{ac}. However, the technical solution of the present disclosure is not limited to this. There may be an even number of the secondary side windings 312, where the even number may be greater than or equal to four. Moreover, in an embodiment, there may be phase deviation among line voltages across corresponding terminals of various secondary side windings 312, thus improving the number of pulses of rectifier equipment, and further improving power factor and reducing line-side harmonic current. Further, as the number of secondary side windings 312 in the phase-shifting transformer 31 is relatively large, the number of pulses of rectifier equipment is relatively large, thus leading to a higher power factor and smaller line-side harmonic current. When compared with the typical system as shown in FIG. 1, the phase-shifting transformer in the embodiment is approximate to an industrial frequency transformer in size and efficiency, with both size and loss of rectifying circuitry and the like smaller than that of a UPS. Therefore, the DC power supply system in the embodiment can achieve higher power density and conversion efficiency. In addition, a conventional UPS shall be subject to relatively complex control, but the system in the embodiment is relatively simple in term of structure and control, thus having higher reliability.

Then, as shown in FIG. 7, uncontrolled rectifiers in the embodiment are realized by using a full bridge rectifier which includes three bridge arms respectively consisting of two series diodes (totally six diodes D1-D6); and low voltage three-phase AC MLV_{ac} outputted by the secondary side windings 312 is respectively inputted to midpoints of the three bridge arms. When compared with the typical system as shown in FIG. 2 where an active rectifier includes an AFE and a DC-DC converter, in the embodiment, a three-phase full bridge rectifier is employed for realizing passive rectification, thus enabling the advantages of fewer devices, lower loss and improved conversion efficiency. Additionally, a conventional AFE or DC-DC converter requires closed-loop control, but the full bridge rectifier is an uncontrolled rectifier, thus is simpler in both structure and control and higher in reliability.

FIG. 8 is a schematic diagram of an uncontrolled rectifying circuitry according to a first embodiment. Corresponding to four groups of low voltage three-phase AC MLV_{ac} outputted by the four secondary side windings 312 as shown in FIG. 6, the uncontrolled rectifying circuitry in the embodiment includes four full bridge rectifiers 81-84 as shown in FIG. 7. Wherein, output terminals of the four full bridge rectifiers 81-84 are respectively connected in parallel with output capacitors C1-C4; output of the full bridge rectifier 81 is connected in series with that of the full bridge rectifier 83, output of the full bridge rectifier 82 is connected in series with that of the full bridge rectifier 84, and outputs of both series connections are connected in parallel with each other to output the foregoing low voltage DC MLV_{dc}. The operating condition of the uncontrolled rectifying circuitry according to the embodiment as shown in FIG. 8 is described as below. MLV_{ac1} is converted by the three-phase full bridge rectifier 81 into MLV_{dc1}, and MLV_{ac2} is converted by the three-phase full bridge rectifier 82 into MLV_{dc2}; similarly, MLV_{ac3} and MLV_{ac4} are respectively converted by the three-phase full bridge rectifiers 83 and 84 into MLV_{dc3} and MLV_{dc4}; MLV_{dc1} is connected in series with MLV_{dc3}, and MLV_{dc2} is connected in series with MLV_{dc4}, then both series connections are connected in parallel with each other to obtain the foregoing low voltage DC MLV_{dc}.

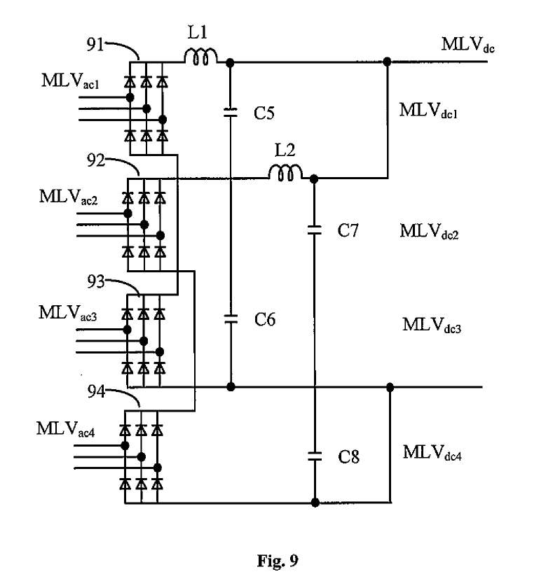

FIG. 9 is a schematic diagram of an uncontrolled rectifying circuitry according to a second embodiment. Corresponding to four groups of low voltage three-phase AC MLV_{ac} outputted by the four secondary side windings 312 as shown in FIG. 6, the uncontrolled rectifying circuitry in the embodiment includes four full bridge rectifiers 91-94 as shown in FIG. 7. Wherein, output terminals of the four full bridge rectifiers 91-94 are respectively connected in parallel with capacitors C5-C8; output of the full bridge rectifier 91 is connected in series with that of the full bridge rectifier 93, output of the full bridge rectifier 92 is connected in series with that of the full bridge rectifier 94, and outputs of both series connections are connected in parallel with each other to output the foregoing low voltage DC. Then, a filter inductor L1 is coupled to a position after the output of the full bridge rectifier 91 is connected in series with that of the full bridge rectifier 93 and before the outputs of both series connections are connected in parallel with each other; and, a filter inductor L2 is coupled to a position after the output of the full bridge rectifier 92 is connected in series with that of the full bridge rectifier 94 and before the outputs of both series connections are connected in parallel with each other. The operating condition of the uncontrolled rectifying circuitry according to the embodiment as shown in FIG. 9 is described as below. MLV_{ac}, is converted by the three-phase full bridge rectifier 91 into MLV_{dc1}, and MLV_{ac2} is converted by the three-phase full bridge rectifier 92 into MLV_{dc2}; similarly, MLV_{ac3} and MLV_{ac4} are respectively converted by the three-phase full bridge rectifiers 93 and 94 into MLV_{dc3} and MLV_{dc4}; MLV_{dc1} is connected in series with MLV_{dc3} and then filtered by the inductor L1 and capacitors C5-C6, MLV_{dc2} is connected in series with MLV_{dc4} and then filtered by the inductor L2 and capacitors C7-C8, then both series connections are connected in parallel with each other to obtain the foregoing low voltage DC MLV_{dc}.

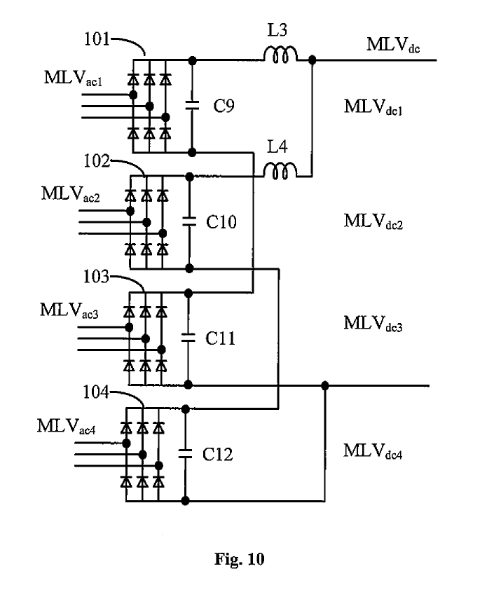

FIG. 10 is a schematic diagram of an uncontrolled rectifying circuitry according to a third embodiment. Corresponding to four groups of low voltage three-phase AC MLV_{ac} outputted by the four secondary side windings 312 as shown in FIG. 6, the uncontrolled rectifying circuitry in the embodiment includes four full bridge rectifiers 101-104 as shown in FIG. 7. Wherein, output of the full bridge rectifier 101 is connected in series with that of the full bridge rectifier 103, further connected in series with a filter inductor L3 and then connected in parallel with capacitors C9 and C11 in series; output of the full bridge rectifier 102 is connected in series with that of the full bridge rectifier 104, further connected in series with a filter inductor L4 and then connected in parallel with capacitors C10 and C12 in series; the capacitors C9 and C11 in series are connected in parallel with the capacitors C10 and C12 in series so as to output the foregoing low voltage DC MLV_{dc}. The operating condition of the uncontrolled rectifying circuitry according to the embodiment as shown in FIG. 10 is described as below. MLV_{ac1} is converted by the three-phase full bridge rectifier 101 into MLV_{dc1}, and MLV_{ac2} is converted by the three-phase full bridge rectifier 102 into MLV_{dc2}; similarly, MLV_{ac3} and MLV_{ac4} are respectively converted by the three-phase full bridge rectifiers 103 and 104 into MLV_{dc3} and MLV_{dc4}; MLV_{dc1} is connected in series with MLV_{dc3} and then filtered by capacitors C9 and C11 and the inductor L3, MLV_{dc2} is connected in series with MLV_{dc4} and then filtered by the capacitors C10 and C12 and inductor L4, then both series connections are connected in parallel with each other to obtain the foregoing low voltage DC MLV_{dc}.

As mentioned above, in the embodiments as shown in FIGS. 9 and 10, filter circuits of the uncontrolled rectifying circuitry are implemented as combination of non-coupling inductors and capacitors. However, the technical solution of the disclosure is not limited to this. Filter circuits may also be employed in other forms. For example, it may be implemented by non-coupling inductors alone.

In the above embodiments, a pulse rectifier circuit is constituted by the phase-shifting transformer 31 and the uncontrolled rectifying circuitry 33. A relative large number of pulses may reduce line-side harmonic current and rectified ripple voltage. In addition, a capacitor may be provided at the input side inside the low voltage DC switchgear 41. In addition, it may be possible to further reduce the rectified ripple voltage by increasing capacitance of the capacitor.

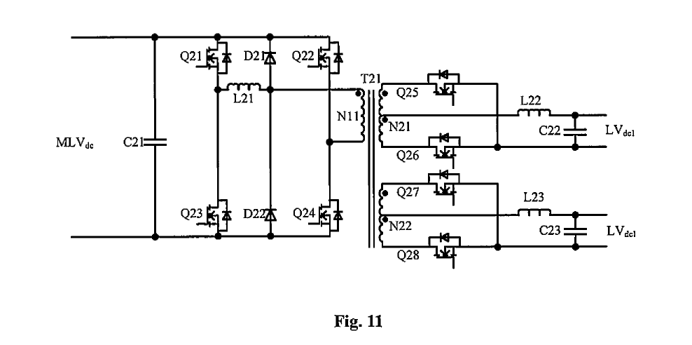

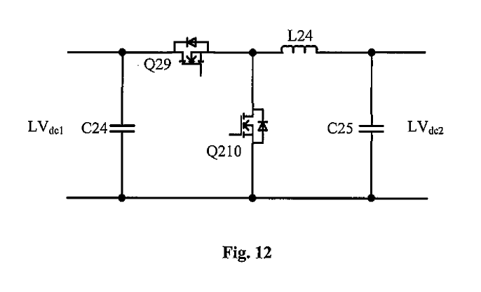

FIG. 11 and FIG. 12 respectively show schematic diagrams of the first-order DC-DC converter 42 and the second-order DC-DC converter 43 according to an embodiment.

As shown in FIG. 11, the first-order DC-DC converter 42 in the embodiment includes a transformer T21, capacitors C21-C23, switching tubes Q21-Q28, diodes D21-D22 and inductors L21-L23. Wherein, the supply low voltage DC MLV_{dc} outputted by the foregoing low voltage DC switchgear 41 is inputted across both ends of the capacitor C21; one end of the capacitor C21 is respectively coupled to one end of the switching tube Q21, one end of the diode D21 and one end of the switching tube Q22; while the other end of the capacitor C21 is respectively coupled to one end of the switching tube Q23, one end of the diode D22 and one end of the switching tube Q24; the other end of the switching tube Q21 is coupled to the other end of the switching tube Q23, the other end of the diode D21 is coupled to the other end of the diode D22, the other end of the switching tube Q22 is coupled to the other end of the switching tube Q24; one end of the inductor L21 is coupled between the switching tube Q21 and the switching tube Q23, while the other end of the inductor L21 is coupled between the diode D21 and the diode D22.

The transformer T21 includes at least a primary winding N11 and two secondary windings N21-N22. One end of the primary winding N11 is coupled between the diode D21 and the diode D22, while the other end of the primary winding N11 is coupled between the switching tube Q22 and the switching tube Q24; one end of the secondary winding N21 is coupled to one end of the switching tube Q25, while the other end of the secondary winding N21 is coupled to one end of the switching tube Q26, and the other end of the switching tube Q25 is coupled to the other end of the switching tube Q26; the center tap of the secondary winding N21 is coupled to one end of the inductor L22, while the other end of the inductor L22 is coupled to one end of the capacitor C22, and the other end of the capacitor C22 is coupled to the other ends of the switching tubes Q25 and Q26; both ends of the capacitor C22 output a group of the foregoing first low voltage DC LV_{dc1}; one end of the secondary winding N22 is coupled to one end of the switching tube Q27, while the other end of the secondary winding N22 is coupled to one end of the switching tube Q28, and the other end of the switching tube Q27 is coupled to the other end of the switching tube Q28; the center tap of the secondary winding N22 is coupled to one end of the inductor L23, while the other end of the inductor L23 is coupled to one end of the capacitor C23, and the other end of the capacitor C23 is coupled to the other ends of the switching tubes Q27 and Q28; both ends of the capacitor C23 output another group of the foregoing first low voltage DC LV_{dc1}.

The operating condition of the first-order DC-DC converter 42 as shown in FIG. 11 is described as below. When both Q21 and Q24 are switched on and both Q22 and Q23 are switched off, Q26 and Q28 are switched on, Q25 and Q27 are switched off, thus one group of LV_{dc1} is outputted from MLV_{dc} via Q21, L21, Q24, T21, Q26, L22 and C22, and another group of LV_{dc1} is outputted from MLV_{dc} via Q21, L21, Q24, T21, Q28, L23 and C23. When both Q22 and Q23 are switched on and both Q21 and Q24 are switched off, Q25 and Q27 are switched on, Q26 and Q28 are switched off, then one group of LV_{dc1} is outputted from MLV_{dc} via Q23, L21, Q22, T21, Q25, L22 and C22, and another group of LV_{dc1} is outputted from MLV_{dc} via Q23, L21, Q22, T21, Q27, L23 and C23.

As shown in FIG. 12, the second-order DC-DC converter 43 in the embodiment includes capacitors C24 and C25, switching tubes Q29 and Q210, and an inductor L24. One group of first low voltage DC LV_{dc1} outputted by the first-order DC-DC converter 42 in the embodiment as shown in FIG. 11 is inputted across both ends of the capacitor C24; one end of the capacitor C24 is coupled to one end of the switching tube Q29, the other end of the switching tube Q29 is respectively coupled to one end of the switching tube Q210 and one end of the inductor L24, while the other end of the inductor L24 is coupled to one end of the capacitor C25, and the other end of the capacitor C25 is coupled to the other end of the capacitor C24 and the other end of the switching tube Q210; and the foregoing second low voltage DC LV_{dc2} is outputted from both ends of the capacitor C25 to the load 44.

The operating condition of the second-order DC-DC converter 43 as shown in FIG. 12 is described as below. When Q29 is switched on and Q210 is switched off, second low voltage DC LV_{dc2} is outputted from LV_{dc1} via Q29, L24 and C25. When Q210 is switched on and Q29 is switched off, conversion channel of LV_{dc1} is cut off, and energy stored in L24 and C25 is converted into the second low voltage DC LV_{dc2} via Q210.

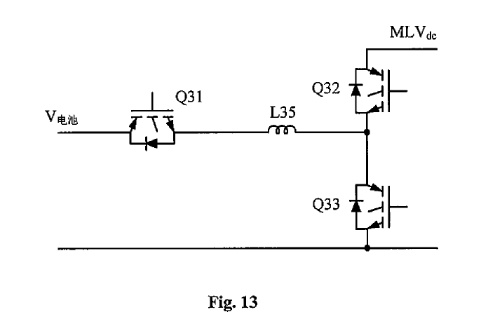

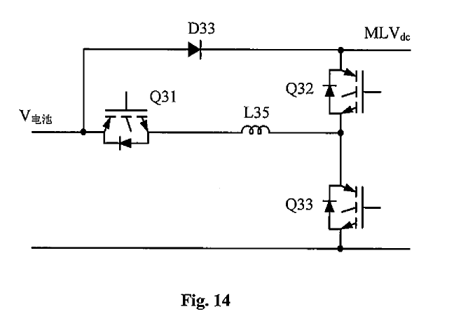

FIG. 13 and FIG. 14 respectively show schematic diagrams illustrating embodiments of the DC/DC converter 52 in the foregoing embodiments.

As shown in FIG. 13, the DC/DC converter 52 in an embodiment includes switching tubes Q31-Q33 and an inductor L35. Wherein, one end of battery voltage V_{battery} from the foregoing backup battery 51 is coupled to one end of the switching tube Q31, the other end of the switching tube Q31 is coupled to one end of the inductor L35, the other end of the inductor L35 is respectively coupled to one end of the switching tube Q32 and one end of the switching tube Q33, the other end of the switching tube Q32 is coupled to one end of the foregoing another low Voltage DC MLV_{dc}, the other end of the switching tube Q33 is respectively coupled to the other end of the battery voltage V_{battery} from the backup battery 51 and the other end of the foregoing another low voltage DC MLV_{dc}.

The operating condition of the DC-DC converter 52 as shown in FIG. 13 is described as below. When both Q31 and Q33 are switched on and Q32 is switched off, the backup battery voltage V_{battery} forms a loop via Q31, L35 and Q33, and energy is stored in L35; when Q33 is switched off while Q31 is kept on, and Q32 is switched on, energy stored in L35 is converted into the low voltage DC MLV_{dc} via Q31 and Q32.

As shown in FIG. 14, on the basis of the embodiment as shown in FIG. 13, the DC-DC converter 52 in another embodiment further includes a diode D33. One end of the diode D33 is respectively coupled to one end of the battery voltage V_{battery} from the backup battery 51 and one end of the switching tube Q31, while the other end of the diode D33 is respectively coupled to the other end of the switching tube Q32 and one end of the foregoing another low voltage DC MLV_{dc}.

The operating condition of the DC-DC converter 52 as shown in FIG. 14 is described as below. When the battery voltage V_{battery} of the backup battery is above the low voltage DC MLV_{dc}, V_{battery} is converted into MLV_{dc} via the diode D33; while when the battery voltage V_{battery} of the backup battery is below the low voltage DC MLV_{dc}, the diode D33 is cut off. Further, when Q31 and Q32 are switched on but Q33 is switched off, MLV_{dc} forms a loop via Q32, L35 and Q31, and MLV_{dc} is converted into V_{battery}; while when Q32 is switched off but Q31 is kept on, and Q33 is switched on, energy stored in L35 is converted into V_{battery} via Q31 and Q33.

Although description of the disclosure is made in reference to a plurality of typical embodiments, it shall be understood that terms used herein are exemplary and explanatory only and are not restrictive. The present disclosure can be concretely implemented in various forms without departing from spirit or essence of the present disclosure. Therefore, it shall be understood that above embodiments are not limited to any foregoing detail, but shall be extensively interpreted with the spirit and scope as defined in appended claims. Thus, all variations and modifications falling within claims or equivalent scope thereof shall be covered by appended claims.

What is claimed is:

1. A DC power supply system, comprising:
a medium voltage AC switchgear, configured to distribute a medium voltage three-phase AC received from an external supply for a next stage;
a phase-shift transformer serving as the next stage, coupled to the medium voltage AC switchgear, and configured to lower the medium voltage three-phase AC received and output four or more groups of low voltage three-phase AC; and
an uncontrolled rectifying circuitry, comprising a plurality of uncontrolled rectifiers configured to receive the four or more groups of low voltage three-phase AC respectively and output a low voltage DC;
wherein the four or more groups of low voltage three-phase AC have a predetermined phase difference between each other.

2. The DC power supply system of claim 1, wherein the low voltage three-phase AC has an even number of groups, and the even number is greater than or equal to 4.

3. The DC power supply system of claim 2, wherein the plurality of uncontrolled rectifiers are divided into a plurality of rectifying groups, each of the rectifying groups comprises an even number of uncontrolled rectifiers connected in series, and the rectifying groups are connected in parallel.

4. The DC power supply system of claim 3, wherein each of the rectifying groups comprises a filter circuit for filtering the low voltage DC.

5. The DC power supply system of claim 4, wherein the filter circuit comprises a non-coupling inductor and a capacitor, the non-coupling inductor is connected with output of the uncontrolled rectifiers in series, and the capacitor is connected with the output of the uncontrolled rectifiers in parallel.

6. The DC power supply system of claim 1, further comprising:
a low voltage DC switchgear, configured to distribute the low voltage DC received to a following stage.

7. The DC power supply system of claim 6, wherein the following stage comprises:
a first-phase DC-DC converter, configured to receive the low voltage DC and output a first low voltage DC.

8. The DC power supply system of claim 7, wherein the following stage further comprises:
a second-phase DC-DC converter, configured to receive the first low voltage DC and output a second low voltage DC to a load.

9. The DC power supply system of claim 6, further comprising:
a backup battery providing a DC voltage; and
a DC/DC converter, connected to the backup battery and configured to transform the DC voltage from the backup battery to the low voltage DC to be delivered to the low voltage DC switchgear.

10. The DC power supply system of claim 1, further comprising:
a standby generator providing a first low voltage three-phase AC; and
a step-up transformer, configured to transform the first low voltage three-phase AC from the standby generator to the medium voltage three-phase AC to be delivered to the medium voltage AC switchgear.

11. The DC power supply system of claim 1, wherein the medium voltage three-phase AC has a voltage range of 1 kV-50 kV, and has a frequency lower than 100 Hz.

12. The DC power supply system of claim 1, wherein the low voltage three-phase AC has a voltage range of 100V-800V, and has a frequency lower than 100 Hz.
